(19) United States
(12) Patent Application Publication
(10) Pub. No.: US 2026/0016002 A1
(43) Pub. Date: Jan. 15, 2026

(54) EMISSIONS COLLECTION SYSTEM

(71) Applicant: C2G Engineering Inc., Huntington, WV (US)

(72) Inventors: Christopher Steven Robertson, Barboursville, WV (US); Stephen Michael Trosclair, Winfield, WV (US); Clinton Shane Ridenour, Winfield, WV (US)

(21) Appl. No.: 18/894,755

(22) Filed: Sep. 24, 2024

Related U.S. Application Data
(60) Provisional application No. 63/668,875, filed on Jul. 9, 2024.

(51) Int. Cl. F04B 49/02; B01D 53/74; F04B 43/02; F04B 43/04

(52) U.S. Cl. CPC F04B 49/022; B01D 53/74; F04B 43/025; F04B 43/04; B01D 2258/02

(57) ABSTRACT

Various embodiments of the present technology relate to solutions for capturing hydrocarbon emissions. In some examples, a system comprises a pressure regulator, an Electric Operated Dual Diaphragm (EODD) vapor pump, a pump pressure gauge, and a process controller. The pressure regulator receives hydrocarbon emissions at an input pressure from an emissions source, maintains the input pressure of the emissions, and passes the hydrocarbon emissions at a pump suction pressure. The EODD ingests the hydrocarbon emissions at the pump suction pressure, pressurizes the hydrocarbon emissions to an output pressure, and transfers the hydrocarbon emissions at the output pressure for delivery to a hydrocarbon emissions collector. The pump pressure gauge measures the pump suction pressure of the hydrocarbon emissions and reports the pump suction pressure. The process controller controls the motor speed of the EODD vapor pump to maintain the hydrocarbon emissions at the pump suction pressure.

### CROSS-REFERENCE TO RELATED APPLICATIONS

This U.S. patent application claims the benefit of and priority to U.S. Provisional Patent Application 63/668,875 titled “EMISSIONS COLLECTION SYSTEM” which was filed on Jul. 9, 2024. U.S. Provisional Patent Application 63/668,875 is incorporated into this U.S. patent application in its entirety.

### TECHNICAL FIELD

Various embodiments of the present technology relate to emissions collection, and more specifically, to capturing low-pressure hydrocarbon emissions.

### BACKGROUND

Hydrocarbon processing systems comprise machinery, equipment, devices, and the like configured to extract hydrocarbons like petroleum, natural gas, or other chemicals for use in energy generation, heating, and chemical production applications. Hydrocarbon processing systems comprise extraction equipment, transfer equipment, and storage equipment. The extraction equipment removes hydrocarbons from subterranean reservoirs. Examples of extraction equipment include drilling rigs and hydraulic fracturing rigs. The transfer equipment transports the extracted hydrocarbons between different geographic locations. Examples of transfer equipment include compressor stations, pipelines, and tankers. The storage equipment stores the hydrocarbons. Examples of storage equipment include bullet tanks and storage vessels. The extraction, storage, and transfer operations often result in intentional or unintentional release of gaseous hydrocarbons into the atmosphere. Exemplary gaseous hydrocarbons include volatile alkanes, alkenes, and alkynes that often form mixtures like natural gas.

The primary component of natural gas is methane (CH₄). Methane is the second most abundant anthropogenic greenhouse gas after carbon dioxide (CO₂). Methane accounts for about 16% of global emissions. Methane is more than 28 times as potent as carbon dioxide at trapping heat in the atmosphere. Over the last two centuries, methane concentrations in the atmosphere have more than doubled, largely due to human-related activities. Although methane is a powerful greenhouse gas, it is also short-lived in the atmosphere when compared to carbon dioxide. Achieving significant reductions in methane emissions would have a rapid and significant effect on atmospheric warming potential.

Hydrocarbon processing systems pressurize natural gas for processing (e.g., fuel use) and transport (e.g., pipeline pressurization). The hydrocarbon processing systems feed the natural gas to compressor stations. The compressor stations utilize reciprocating compressors to pressurize natural gas. A reciprocating compressor comprises a rotating member coupled to a piston that compresses input natural gas to a desired output pressure. The piston rods comprise packing to seal the piston compression chamber. The piston rod packing systems are designed to leak small amounts of natural gas which increases the operating life of the compressor. For example, overtightening the packing on the piston rod increases the friction between the packing and the piston rod thereby increasing the wear on the packing to an undesirable level. There are more than 51,000 reciprocating compressors operating in the U.S. natural gas industry. The compressors have an average of four cylinders, representing over 200,000 piston rod packing systems in service. These systems contribute over 72.4 billion cubic feet per year of methane emissions to the atmosphere.

Reciprocating compressors typically leak natural gas at low volumes (e.g., 7,000 cubic feet per day) at low pressures (e.g., 0.20-2.00 Pounds per Square Inch (psi)). The low volumes and low-pressures increase the difficulty of capturing the leaked natural gas. Conventional emissions collection systems typically utilize a pump or some other type of pressure differential to draw off leaked natural gas. Operating a pump at too high of a speed to capture reciprocating compressor emissions induces a vacuum in the reciprocating compressor causing oxygen to enter the compressor which is a safety hazard. Conventional pumps are typically not economically viable as they require greater amounts of power to operate than what can be extracted from the captured natural gas. Unfortunately, conventional emissions capture systems do not effectively or efficiently capture low-pressure natural gas emissions from reciprocating compressors.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for hydrocarbon processing and storage systems. Some embodiments comprise a method to collect hydrocarbon emissions. The method comprises a pressure regulator receiving hydrocarbon emissions at an input pressure from an emissions source, maintaining the input pressure of the hydrocarbon emissions, and passing the hydrocarbon emissions at a pump suction pressure to an Electric Operated Dual Diaphragm (EODD) vapor pump. The method further comprises the EODD vapor pump ingesting the hydrocarbon emissions at the pump suction pressure, pressurizing the hydrocarbon emissions to an output pressure, and transferring the hydrocarbon emissions at the output pressure for delivery to a hydrocarbon emissions collector. The method further comprises a pump pressure gauge measuring the pump suction pressure of the hydrocarbon emissions and reporting the pump suction pressure to a process controller. The method further comprises the process controller controlling a motor speed of the EODD vapor pump to maintain the hydrocarbon emissions at the pump suction pressure.

Some embodiments comprise a system to collect hydrocarbon emissions. The system comprises a pressure regulator, an EODD vapor pump, a pump pressure gauge, and a process controller. The pressure regulator receives hydrocarbon emissions at an input pressure from an emissions source, maintains the input pressure of the hydrocarbon emissions, and passes the hydrocarbon emissions at a pump suction pressure. The EODD ingests the hydrocarbon emissions at the pump suction pressure, pressurizes the hydrocarbon emissions to an output pressure, and transfers the hydrocarbon emissions at the output pressure for delivery to a hydrocarbon emissions collector. The pump pressure gauge measures the pump suction pressure of the hydrocarbon emissions and reports the pump suction pressure. The process controller controls the motor speed of the EODD vapor pump to maintain the hydrocarbon emissions at the pump suction pressure.

Some embodiments comprise one or more non-transitory computer readable storage media having program instructions stored thereon to implement a control scheme for an emissions collection system. The program instruction, when executed by a computing system, direct the computing system to perform operations. The operations comprise obtaining a pump suction pressure measurement that indicates pump suction pressure to an Electric Operated Dual Diaphragm (EODD) vapor pump. The EODD vapor pump pressurizes and transfers captured hydrocarbon emissions. The operations further comprise controlling a motor speed of the EODD vapor pump to maintain the pump suction pressure at a set point based on the pump suction pressure measurement. The operations further comprise obtaining an input pressure measurement of the hydrocarbon emissions, an output pressure measurement of the hydrocarbon emissions, and an oxygen concentration measurement of the hydrocarbon emissions. The operations further comprise comparing the input pressure measurement to an input pressure threshold, the output pressure measurement to an output pressure threshold, and the oxygen content measurement to an oxygen content threshold. The operations further comprise detecting that one or more of the input pressure threshold, the output pressure threshold, or the oxygen content threshold are triggered. The operations further comprise, transferring, in response to the one or more triggered thresholds, control signals to deactivate the EODD vapor pump, close a pump input valve, close a pump output valve, and open a bypass valve to release the hydrocarbon emission to the atmosphere.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an emissions capture system.

FIG. 2 illustrates an exemplary operation of the emissions capture system.

FIG. 3 illustrates an exemplary operation of the emissions capture system.

FIG. 4 illustrates a natural gas emissions capture system.

FIG. 5 further illustrates the natural gas emissions capture system.

FIG. 6 illustrates a Programmable Logic Controller (PLC) in the natural gas emissions capture system.

FIG. 7 illustrates a compressor station in the natural gas emissions capture system.

FIG. 8 illustrates a fuel storage system in the natural gas emissions capture system.

FIG. 9 illustrates an Electric Operated Dual Diaphragm (EODD) vapor pump in the natural gas emissions capture system.

FIG. 10 illustrates a schematic view of the EODD vapor pump in the natural gas emissions capture system.

FIG. 11 further illustrates the PLC in the natural gas emissions capture system.

FIG. 12 illustrates an exemplary operation of the natural gas emissions capture system.

FIG. 13 illustrates an exemplary computing system.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Reciprocating compressors are used to pressurize natural gas. The piston rods of the compressors are sealed with rod packing. The rod packing is designed to leak a small amount of natural gas through rod packing vents to extend the operational life of the compressor. Rod packing vents have historically been piped to the atmosphere and are a chronic emission source of methane. New Environmental Protection Agency (EPA) regulations took effect for the Oil and Gas sector on May 7, 2024. The new EPA regulations are defined in the 40 Code of Federal Regulations (CFR) Part 60 titled Standards of Performance for New, Reconstructed, and Modified Sources and Emissions Guidelines for Existing Sources: Oil and Natural Gas Sector Climate Review. The regulations stipulate that operators must now perform a volume test of rod packing leaks approximately annually (8,760 run hours) on each compressor. If the leak rate exceeds 2 standard cubic feet per minute (scfm) per compressor cylinder, the rod-vent packing must be replaced within a specified time. Compliance with the new regulations still allows for these methane emissions to be vented into the atmosphere continuously.

The EPA allows an exemption from this testing and continual venting if the operators collect the methane and Volatile Organic Compounds (VOCs) emissions from the reciprocating compressor rod packing using a rod packing emissions collection system. The EPA requires the emissions collection system to route the rod packing emissions to a process through a closed vent (e.g., closed loop) system. Currently available rod packing capture systems in the industry have performed poorly or are ineffective in certain applications and configurations. Rod packing vents are essentially at ambient pressure, creating a situation where oxygen could be introduced into the process gas, leading to safety concerns.

Various embodiments of the present technology include an emission collection system that comprises a compact skid mounted unit that meets or exceeds the new EPA regulations as a closed vent system. The emissions collection systems described herein may collect emissions from compressor rod-vents, tanks, gas driven pneumatic devices, pumps, and the like. The emission collection system utilizes a unique technology with an Electric Operated Dual Diaphragm (EODD) vapor pump that reduces the horsepower needed to take these vapors from ambient pressures and increasing them to viable process pressures. The EODD vapor pump has the capability to pressure low volumes of gas from atmospheric pressure to operating pressures upwards of 60 psi. For example, a conventional compressor would require around 15 horsepower to achieve similar results while the EODD vapor pump requires around 5 horsepower. Moreover, the EODD vapor pump has a low number of moving parts which increases reliability when compared with conventional compressors. The emission detection system incorporates a PLC (Programmable Logic Controller) with a VFD (Variable Frequency Drive) along with an engineered selection of valves. The PLC controls the VFD to run the EODD pump to maintain a small but positive pressure (0.5 psi) on the packing vent system. The PLC monitors system pressure and controls the pump speed using the VFD to maintain this pressure. This positive pressure inhibits a vacuum from forming in the reciprocating compressor that may introduce oxygen into the emissions capturing process. The emissions collection systems successfully maintain the positive pressure despite vapor volumes swinging from as low as 2.1 to as high as 10.4 scfm.

In addition to the rod packing vents, the reciprocating compressors typically comprise two drain lines on the bottom of each compressor, the distance piece drain and the packing vent drain. These lines are intended to route used lubrication oil from the compressor to a sump or tank for recycling or disposal. While emissions leak through the rod packing vents at the top of each reciprocating compressor cylinder, the emissions may also escape through the two drain lines. The emissions capture system incorporates a small vessel to collect the oil and separate the emissions which reduces the possibility of leaks through the drainage system. In addition, the emissions capture system measures the amount of leaked oil which provides valuable data to customers warning them of variations in their critical lubrication system.

The EPA has required new standards of reporting for closed vent systems. The emission collection systems described herein provide real-time visibility and control through VT Supervisory Control and Data Acquisition (SCADA). Alarms and reporting can be tailored for stand-alone applications or securely integrated into a customer's existing systems. Operators can be notified quickly if there has been an upset in the process. Daily, monthly, and annual reports of volumes recovered, runtimes, and volumes emitted can be automatically generated for delivery to the necessary agencies. Now referring to the Figures.

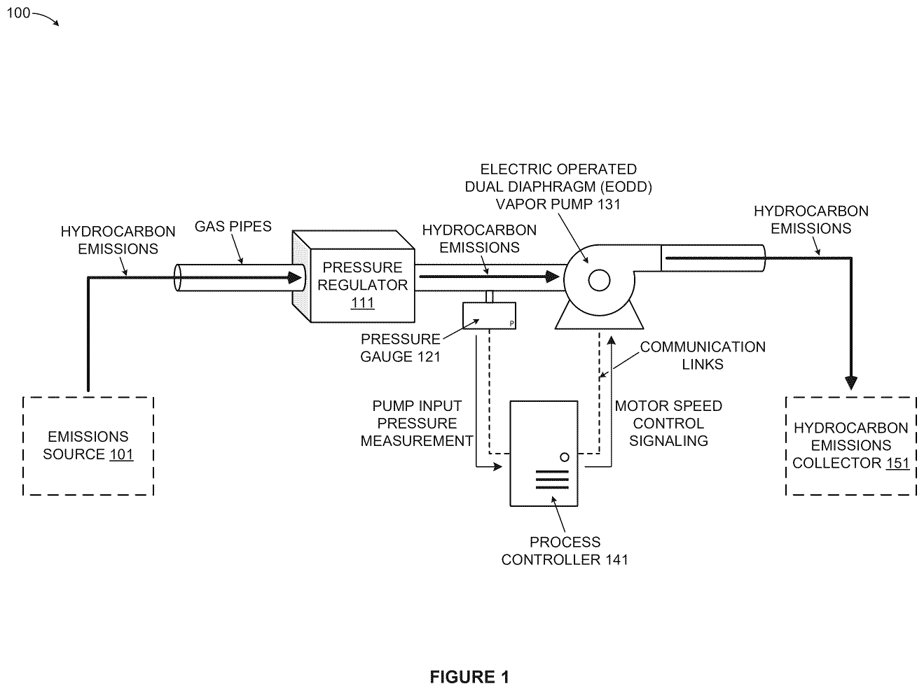

FIG. 1 illustrates emissions collection system 100 to capture hydrocarbon (and/or other) emissions from an emissions source. Emissions collection system 100 provides services like emissions capture, emissions processing, emissions recycling, system control, emissions data generation, alert notification, and/or some other type of emissions capture product. Emissions collection system 100 comprises emissions source 101, pressure regulator 111, pressure gauge 121, Electric Operated Dual Diaphragm (EODD) vapor pump 131, process controller 141, and hydrocarbon emission collector 151. In other examples, emissions collection system 100 may include fewer or additional components than those illustrated in FIG. 1. Likewise, the illustrated components of emissions collection system 100 may include fewer or additional components, assets, or connections than shown. For example, emissions collection system 100 may comprise three pressure gauges and two flowmeters. Process controller 141 may be representative of a single computing apparatus or multiple computing apparatuses.

Various examples of emission collection system configuration and operation are described herein. In some examples, emissions source 101 leaks hydrocarbon emissions. For example, emissions source 101 may leak natural gas, methane, ethane, propane, butane, and the like. Pressure regulator 111 is operatively coupled to emissions source 101 and receives the hydrocarbon emissions at an input pressure (also referred to as rod vent pressure). For example, a pipe may couple pressure regulator 111 to a vent on emissions source 101 that leaks the hydrocarbon emissions. Pressure regulator 111 maintains the input pressure of the hydrocarbon emissions at regulator 111's inlet. As the hydrocarbons flow through regulator 111, the pressure of the emissions reduces to a pump suction pressure. For example, regulator 111 may maintain the emissions at 0.5 psi at its inlet and output the hydrocarbon emissions at 0.25 psi. Pressure regulator 111 passes the hydrocarbon emissions at the pump suction pressure to EODD vapor pump 131. EODD vapor pump 131 receives the hydrocarbon emissions and pressurizes the emissions to an output pressure (e.g., from 0.25 psi to 40 psi). EODD vapor pump 131 transfers the hydrocarbon emissions at the output pressure to hydrocarbon emissions collector 151. EODD vapor pump 131 may measure and record these volumes and report the volumes to process controller 141. As EODD vapor pump 131 operates, pressure gauge 121 measures the pump suction pressure and reports the pump suction pressure to process controller 141. Process controller 141 controls the motor speed of EODD vapor pump 131 to maintain the pump suction pressure at a setpoint (e.g., 0.25 psi). Process controller 141 generates control signaling based on the pressure measurement and transfers the control signaling to vapor pump 131. EODD vapor pump 131 drives its motor at the speed indicated by the control signaling. Advantageously, emissions collection system 100 effectively, efficiently, and economically captures low-pressure hydrocarbon emissions from emissions sources like reciprocating compressors.

Emissions source 101 may comprise a storage tank, compressor, reciprocating compressor rod packing vent, pipeline, and/or some other type of hydrocarbon storage, processing, or transfer equipment. Pressure regulator 111 may comprise a back pressure regulator, pressure reducing regulator, single stage regulator, double stage regulator, check valve, and/or some other type of fluid control valve. Pressure gauge 121 may comprise a Bourdon tube gauge, diaphragm pressure gauge, bellows pressure gauge, absolute pressure gauge, differential pressure gauge, digital gauge, and/or some other type of pressure measurement instrument. EODD vapor pump 131 comprises feed lines, output lines, Alternating Current (AC) electric motors, cooling fans, power supplies, motor drives, VFDs, actuators, pump chambers, drive shafts, eccentric cams, diaphragms, diaphragm pins, diaphragm pin carriages, ball valves, carbon dioxide tanks, carbon dioxide regulators, carbon dioxide feed lines, carbon dioxide ports, and the like. Process controller 141 may comprise one or more Programmable Logic Controllers (PLCs), Distributed Control Systems (DCSs), Programmable Automation Controllers (PACs), Remote Terminal Units (RTUs), microcontrollers, Filed Programmable Gate Arrays (FPGAs), soft PLCs, Proportional-Integral-Derivative (PID) controllers, and the like. Hydrocarbon emissions collector 151 may comprise a storage tank, pipeline, fuel line, fuel tank, chemical processing line, and/or some other type of hydrocarbon storage, processing, or transfer equipment.

Pressure gauge 121, EODD vapor pump 131, and process controller 141 comprise wireless and/or wireline communication circuitry. The wireless/wireline communication circuitry comprises antennas, amplifiers, filters, modulation, analog/digital interfaces, microprocessors, software, memories, transceivers, bus circuitry, and the like. The communication circuitry may communicate over links using wireless and/or wireline technologies like Institute of Electrical and Electronic Engineers (IEEE) 802.3 (Ethernet), IEEE 802.11 (WiFi), Sixth Generation Radio (6GR), Fifth Generation New Radio (5GNR), Long Term Evolution (LTE), Low-Power Wide Area Network (LP-WAN), Bluetooth, Division Multiplex (TDM), Data Over Cable System Interface Specification (DOCSIS), Internet Protocol (IP), General Packet Radio Service Transfer Protocol (GTP), virtual switching, inter-processor communication, bus interfaces, and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Pressure gauge 121, EODD vapor pump 131, and process controller 141 may comprise computing systems. The computing systems comprise microprocessors, software, memories, transceivers, bus circuitry, and the like. The microprocessors comprise Central Processing Units (CPU), Graphical Processing Units (GPU), Application-Specific Integrated Circuits (ASIC), Field Programmable Gate Array (FPGA), Digital Signal Processor (DSP), analog computing devices, and/or types of processing circuitry. The memories comprise Random Access Memory (RAM), Solid State Drives (SSDs), Hard Disk Drives (HDDs), Non-Volatile Memory Express (NVMe) SSDs, and/or the like. The memories store software like operating systems, control applications, Proportional-Integral-Derivative (PID) applications, control applications, Human Machine Interface (HMI) applications, machine learning models, user applications, data collection application, alarm applications, and the like. The microprocessors retrieve the software from the memories and execute the software to drive the operation of emission collections system 100 as described herein. While illustrated and described as capturing hydrocarbon emissions, in other examples emissions collection system 100 may capture other types of emissions like water vapor, carbon dioxide, and the like.

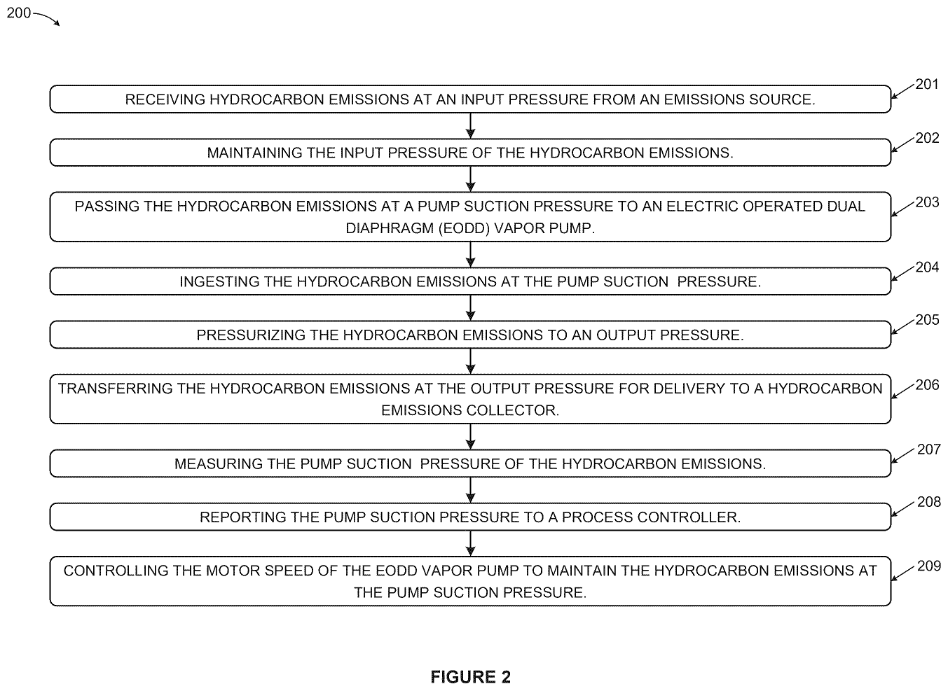

FIG. 2 illustrates process 200. Process 200 comprises an exemplary operation of emissions collection system 100 to capture hydrocarbon emissions from an emissions source. In other examples, process 200 may differ. The operations of process 200 comprise receiving hydrocarbon emissions at an input pressure from an emissions source (step 201). The operations further comprise maintaining the input pressure of the hydrocarbon emissions (step 202). The operations further comprise passing the hydrocarbon emissions at a pump suction pressure to an EODD vapor pump (step 203). The operations further comprise ingesting the hydrocarbon emissions at the pump suction pressure (step 204). The operations further comprise pressurizing the hydrocarbon emissions to an output pressure (step 205). The operations further comprise transferring the hydrocarbon emissions at the output pressure for delivery to a hydrocarbon emissions collector (step 206). The operations further comprise measuring the pump suction pressure of the of the hydrocarbon emissions (step 207). The operations further comprise reporting the pump suction pressure to a process controller (step 208). The operations further comprise controlling the motor speed of the EODD vapor pump to maintain the hydrocarbon emissions at the pump suction pressure (step 209).

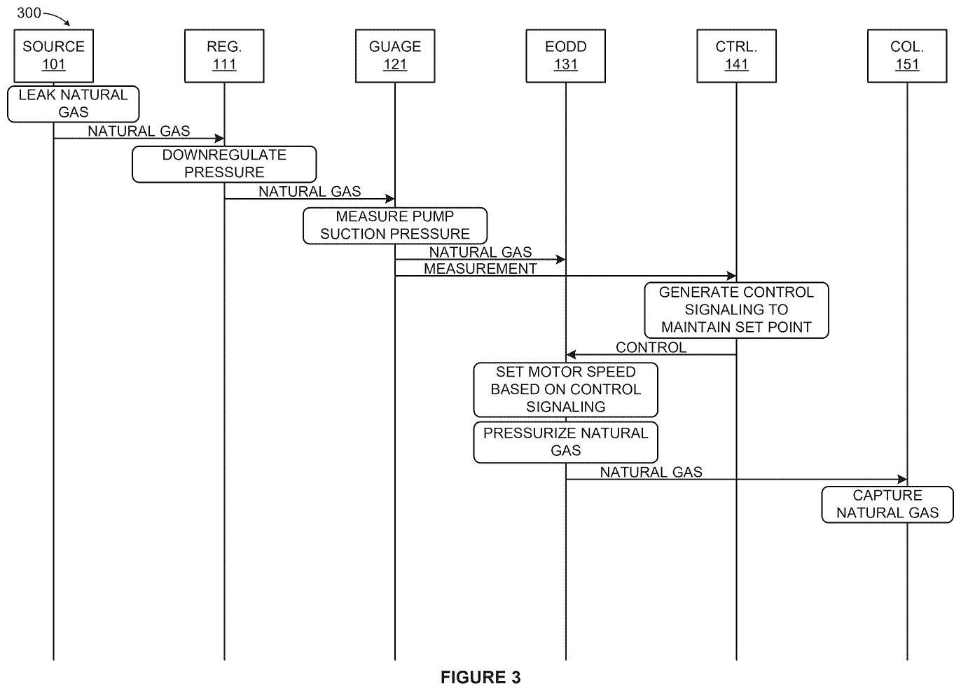

FIG. 3 illustrates process 300. Process 300 comprises an exemplary operation of emissions collection system 100 to capture hydrocarbon emissions from an emissions source. Process 300 comprises an example of process 200 illustrated in FIG. 2, however process 200 may differ. In other examples, process 300 may differ. In some examples, emissions source 101 comprises a natural gas compressor to pressurize natural gas for downstream pressure. When operating to compress the natural gas, a portion of the natural gas leaks at low pressure (e.g., 0.5 psi) into a pressure relief vent coupled to pressure regulator (REG.) 111. The low-pressure natural travels to pressure regulator 111.

Regulator 111 comprises a back pressure regulator that maintains input pressure towards emissions source 111. When pressure of the leaked natural gas exceeds the setpoint of regulator 111, the natural gas flows at reduced pressure to EODD vapor pump 131. When pressure of the leaked natural gas is below the setpoint of regulator 111, regulator 111 closes arresting the flow of natural gas to EODD vapor pump 131 which allows the input pressure to increase and inhibits a vacuum from forming in source 101. Regulator 111 receives the low-pressure natural gas and flows the gas to EODD vapor pump 131 at a reduced pressure. Pressure gauge 121 measures the pressure of the flowing natural gas and reports the measurement to process controller 141. The measurement may be continuous or period (e.g., one measurement per second). The pressure measurement indicates the pressure at the inlet of EODD vapor pump 131.

Process controller 141 receives the pressure measurement from pressure gauge 121. Process controller 141 utilizes a VFD along with an engineered selection of valves to precisely control the motor speed of EODD vapor pump 131. Process controller 141 generates and transfers control signals to EODD vapor pump 131. The control signals control the motor speed of pump 131 to maintain the inlet pressure at the pressure set point. EODD pump 131 receives and executes the control signals and adjusts the power supplied to its electric motor. The electric motor slows/accelerates based on the change in power. The spinning of the electric motor drives an eccentric cam that rotates to oscillate internal pump diaphragms to create a pressure differential that draws the natural gas into pump 131 at the setpoint input pressure. In other examples, EODD pump 131 may utilize a different or additional pressure differential device (e.g., an impellor). EODD pump 131 pressurizes the natural gas and transfers pressurized natural gas to collector (COL.) 151. EODD pump 131 successfully maintains pressures in the range of 0.20-2.00 psi despite vapor volumes swinging from as low as 2.1 to as high as 10.4 scfm. This positive pressure prevents a vacuum from occurring in emissions source 101 that could introduce oxygen into the process. In this example, hydrocarbon emissions collector 151 is representative of a fuel line to the compressor of emissions source 101. Collector 151 receives the pressurized natural gas which is then used to power the compressor.

In some examples, process controller 141 collects additional process variables like input pressure (i.e., the pressure upstream of regulator 111), output pressure (i.e., the pressure downstream of EODD vapor pump 131, and oxygen concentration (i.e., proportion of oxygen in the hydrocarbon emissions) to detect and mitigate unsafe system operation. Process controller 141 may interface with input pressure gauges (not illustrated), output pressure gauges (not illustrated), and oxygen concentration sensors (not illustrated) to obtain this data. Process controller 141 compares the input pressure to an input pressure threshold, the output pressure to an output pressure threshold, and the oxygen concentration to an oxygen concentration threshold. When any of the thresholds are triggered, process controller 141 controls system 100 to enter bypass mode to mitigate unsafe operating conditions. For example, the input pressure threshold may be triggered when input pressure falls outside of 0.20-2.00 psi, the output pressure threshold may be triggered when output pressure falls outside of 20-100 psi, and the oxygen concentration threshold may be triggered when oxygen concentration exceeds 5%. To enter bypass mode, process controller 141 transfers control signals to deactivate EODD vapor pump 131. Process controller 141 closes valves (not illustrated) to block hydrocarbon emissions from emissions source 101 and to hydrocarbon emissions collector 151. Process controller 141 opens a bypass valve (not illustrated) to vent the hydrocarbon emissions to the atmosphere. Process controller 141 sends an alarm to operations via a SCADA system (not illustrated) to notify personnel of bypass conditions. Process controller 141 continues to monitor the process data to detect when the triggered thresholds are no longer triggered. Bypassed volumes to atmosphere may be measured/recorded by a flowmeter (not illustrated) for regulatory reporting requirements (e.g., as established by the new EPA regulations). When bypass conditions subside, process controller 141 transfers control signals to open the input/output valves, close the bypass valves, and reactivate EODD vapor pump 131 to begin capturing hydrocarbon emissions from source 101.

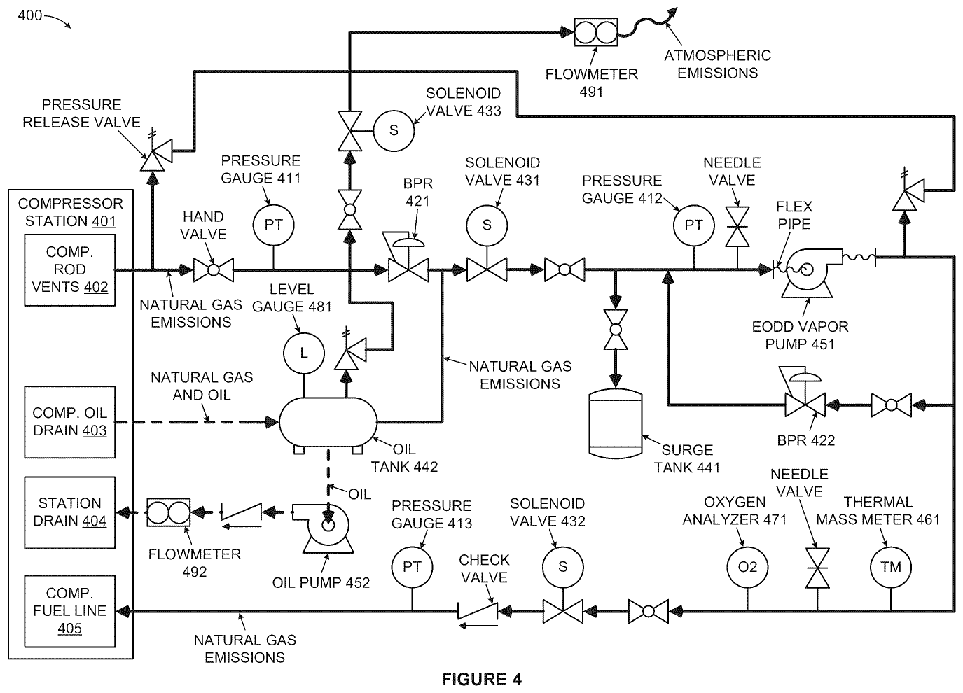

FIG. 4 illustrates natural gas emissions capture system 400 to capture and recycle natural gas. Natural gas emissions capture system 400 comprises an example of emissions collection system 100 illustrated in FIG. 1, however emissions collection system 100 may differ. Natural gas emissions capture system 400 comprises compressor station 401, pressure gauges 411-413, Back Pressure Regulators (BPRs) 421 and 422, solenoid valves 431-433, surge tank 441, oil tank 442, EODD vapor pump 451, oil pump 452, thermal mass meter 461, oxygen analyzer 471, level gauge 481, and flowmeters 491 and 492. Natural gas emissions capture system 400 comprises additional illustrated components like hand valves, pressure release valves, needle valves, check valves, and flex pipes. Compressor station 401 comprises compressor (COMP.) rod vents 402, compressor oil drain 403, station drain 404, and compressor fuel line 405.

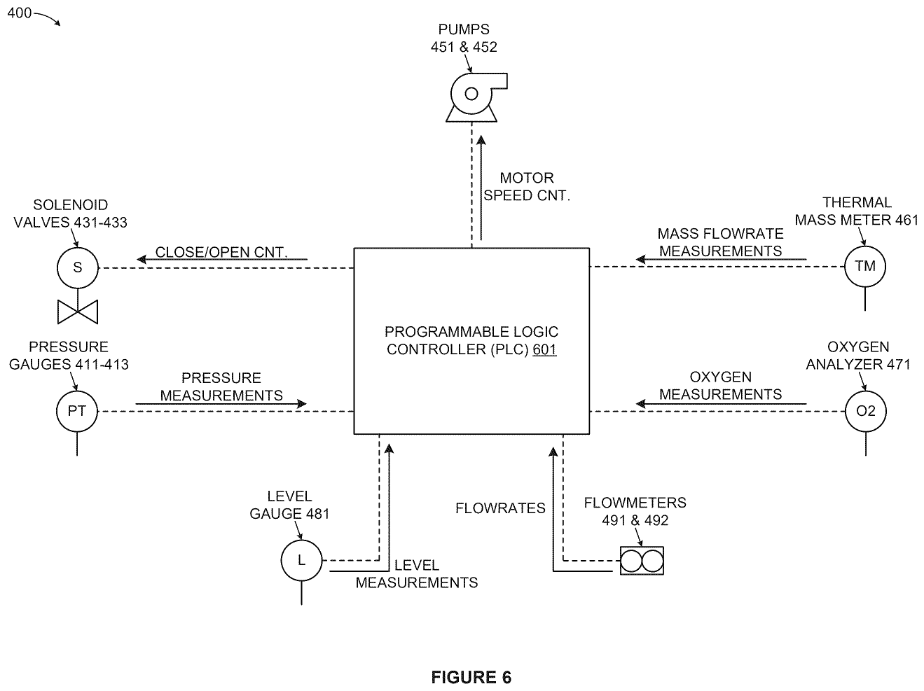

The bold arrows illustrated connecting the various components of natural gas emissions capture system 400 are representative of natural gas flows, natural gas and oil flows, and oil flows. These flows are typically carried by one-to-two-inch diameter pipes that operatively couple the illustrated components. Natural gas emissions capture system 400 comprises fluid pipes, communication links, power links, and computing devices (e.g., PLCs), however these components are omitted for clarity. The PLC and communication links present in natural gas emissions capture system 400 are illustrated in FIG. 6. In other examples, natural gas emissions capture system 400 may comprise different or additional elements than those illustrated in FIG. 4.

In some examples, compressor station 401 receives natural gas and utilizes reciprocating compressors to pressurize the natural gas for applications like fuel use, chemical processing, transport, and the like. As the reciprocating compressors operate, a portion of the natural gas leaks through the compressor seals and is released through compressor rod vents 402 as natural gas emissions. The rod vent emissions are collected from the top of each distance piece of the compressors and manifolded into a common line. The piping of one or more compressors within station 401 may be co-mingled into this circuit. The pressure of the natural gas emissions is typically low (e.g., 0.20-2.00 psi) and the volumetric flow rate of the natural gas emissions is also typically low (e.g., 6,000-8,000 cubic ft per day). At this point, the pressure of the natural gas emissions is too low to open the input side pressure release valve and the natural gas emissions instead flow through the hand valve to pressure gauge 411. Pressure gauge 411 measures the pressure of the input natural gas emissions and generates data indicating natural gas pressure over time. This reading may be referred to as rod vent pressure. The natural gas emissions continue to BPR 421. BPR 421 maintains the natural gas emissions at an input pressure threshold (e.g., 0.5 psi) and passes the emissions downstream when the input pressure threshold is exceeded. BPR 421 is set at 0.5 psi (or another acceptable pressure) to maintain positive pressure on compressor rod vents 402 to inhibit a vacuum that could introduce oxygen into the line. When the pressure of natural gas emissions is below the pressure threshold of BPR 421, BPR 421 closes to inhibit the downstream flow.

The natural gas emissions pass BPR 421 at a reduced pressure (e.g., 0.25 psi) and enter solenoid valve 431. Solenoid valve 431 is set to an open position during normal operating conditions. The natural gas emissions pass solenoid valve 431 and two hand valves before filling surge tank 441. Gas pressure downstream of the BPR 421 is approximately 0.25 psi (or another pressure depending on the system configuration) as it enters surge tank 441. Surge tank 441 maintains a reservoir of gas emissions to buffer EODD vapor pump 451 against abrupt changes in natural gas volume. The natural gas emissions pass surge tank 441 to pressure gauge 412. Pressure gauge 412 measures the suction pressure of the emissions and generates data that indicates the suction pressure of the natural gas entering EODD pump 451 over time. Suction pressure is the process variable for the logic and is the reference that the PLC (not illustrated) seeks to maintain by controlling pump speed. After measurement, the natural gas emissions pass a needle valve and enter EODD vapor pump 451 through a flex pipe. EODD vapor pump 421 pulls the natural gas emission and pressurizes the emissions to an operating pressure (e.g., 20-100 psi). EODD vapor pump 421 operates in response to control signaling received from a PLC. The control signaling sets the motor speed of EODD vapor pump 421 to maintain a pump suction pressure setpoint (e.g., 0.25 psi) based on the suction pressure recorded by pressure gauge 412. EODD vapor pump 421 transfers the pressurized natural gas emissions towards compressor station 401. If the volume of the natural gas emissions is insufficient to maintain suction pressure, the pressurized emissions are recirculated to surge tank 441 through make-up BPR 422.

During normal operations, the pressure release valve downstream of EODD vapor pump 451 is closed and EODD vapor pump 451 transfers the pressurized natural gas to thermal mass meter 461. Thermal mass meter 461 comprises two temperature sensors and a heating element. The first temperature sensor measures the temperature of the natural gas received by thermal mass meter 461. The heating element heats the natural gas after it passes the first temperature sensor. The second temperature sensor measures the heat to the natural gas after it is heated by the heating element. Thermal mass meter 461 correlates the temperature change to a mass flowrate and generates data characterizing the mass flowrate over time. After the mass flowrate is measured, the pressurized gas passes a needle valve and travels to oxygen analyzer 471. Oxygen analyzer 471 comprises a pair of electrodes. One of the electrodes contacts the pressurized natural gas and the other electrode contacts the ambient air. Oxygen analyzer 471 applies an electric potential to the electrodes. Oxygen analyzer determines the proportion of oxygen in the pressurized natural gas based on the voltage difference between the two electrodes and generates data characterizing the natural gas oxygen concentration over time.

After the oxygen concentration is measured, the natural gas passes a hand valve and enters solenoid 432. Solenoid valve 432 is open during normal operating conditions. The natural gas passes through solenoid valve 432 and enters a check valve. The check valve inhibits back flow in the gas line. The natural gas passes through the check valve to pressure gauge 413. Pressure gauge 413 measures the output pressure of the captured natural gas and generates data that indicates the output pressure over time. The natural gas emissions flow to compressor station 401 where they are fed to compressor fuel line 405. There, the captured natural gas emissions are burned to power the reciprocating compressor. In other example, the captured natural gas emissions may instead be transferred to another system associated with compressor station 401 (e.g., a storage, tank, pipeline, tanker truck, etc.).

Contemporaneously, as the reciprocating compressors of compressor station 401 operate, excess lubrication oil (e.g., from along the piston rod) leaks via compressor oil drain 403. Natural gas leaks through the drain line and/or may dissolve into the lubrication oil. Consequently, compressor oil drain 403 transfers a mixture of natural gas and lubrication oil to oil tank 442. Reciprocating compressors typically comprise two lubricating oil drain lines referred to as a distance piece drain and a packing vent drain, however these lines are combined into oil drain 403 for sake of clarity. In oil tank 442, the natural gas leaked through oil drain 403 leaked fills the free space of oil tank 442. Additionally, natural gas (along with other VOCs) dissolved in the lubrication oil vaporizes to fill the free space in oil tank 442. The released natural gas emissions travel to a junction with the natural gas emissions received from compressor rod vents 402 before solenoid valve 431. There, the two flows combine and travel to through solenoid 431 and are pressurized by EODD vapor pump 451 as described above. During normal operations, solenoid valve 433 is closed which inhibits flow of the natural gas out of natural gas emissions capture system 400 thereby driving the natural gas from oil tank 442 towards the junction. By plumbing vents upstream of the back pressure valve and drains downstream of the valve, gravity flow of oil is ensured.

Level gauge 481 measures the oil level in oil tank 442 and generates data indicating the oil level over time. When the measured oil level exceeds a set point, oil pump 452 receives control signaling that activates the motor of oil pump 452. Oil pump 452 pulls the oil from oil tank 442 and transfers the oil past a check valve to flowmeter 492. Flowmeter 492 measures the volumetric flow rate of the drained lubrication oil and generates data that indicates the volumetric flow rate over time. This data can be used to identify when the oil in compressor station 401 needs to be replaced. The oil travels to compressor station 401 where it is disposed of in station drain 404. When the measured oil level falls below the set point, oil pump 452 receives control signaling that deactivates the motor of oil pump 452 to allow oil tank 442 to refill.

During abnormal operating conditions, natural gas emissions capture system 400 enters bypass mode to mitigate safety hazards. The safety hazards include excessive input/output pressure, minimal input/output pressure, excessive oxygen concentration, and the like. For example, bypass mode may be triggered when pressure gauge 411 measures a system input pressure less than 0.20 psi or greater than 2.00 psi, when pressure gauge 413 measures an output pressure less than 20 psi or greater than 100 psi, and/or when oxygen analyzer 471 measures an oxygen concretion that exceeds 5%. Threshold high input pressure indicates the pressure/volume of the natural gas emission are more than EODD vapor pump 451 can process. Threshold low input pressure indicates that pressure is approaching a vacuum that may introduce oxygen into the process. Threshold high output pressure indicates an upset in the gas capture process preventing discharge (e.g., blocked fuel line). Threshold low output pressure indicates a possible leak in the process. Threshold high oxygen concentration indicates unsafe levels of oxygen have been introduced into the process. The specific bypass thresholds may be preset, automated, operator configured, and/or defined using machine learning or artificial intelligence tools. The specific bypass thresholds typically depend in part on the specific application of compressor station 401.

When bypass mode is triggered, solenoid valves 431 and 432 close and solenoid valve 433 opens. EODD vapor pump 451 deactivates in response to control signaling received from the PLC. The opening of solenoid valve 433 to atmosphere prevents any pressure build up on the distance pieces or upstream piping. Since both compressor rod vents 402 and compressor oil drain 403 are also tied to the same compressor distance piece, the oil system (e.g., oil tank 442) does not overpressure. The natural gas emissions travel towards flow meter 491. Flowmeter 491 measures the volumetric flowrate of the natural gas emissions and generates data indicating the volumetric flowrate of the emissions over time. After the flowrate is measured, the natural gas emissions are vented to the atmosphere.

When the threshold conditions that triggered bypass mode are no longer present, natural gas emissions capture system 400 exits bypass mode. To exit bypass mode, solenoid valves 431 and 432 open and solenoid valve 433 close. EODD vapor pump 451 activates in response to control signaling from the PLC to restart the flow of natural gas towards compressor fuel line 405. Flowmeter 491 stops receiving natural gas and the natural gas emissions stop being vented to the atmosphere.

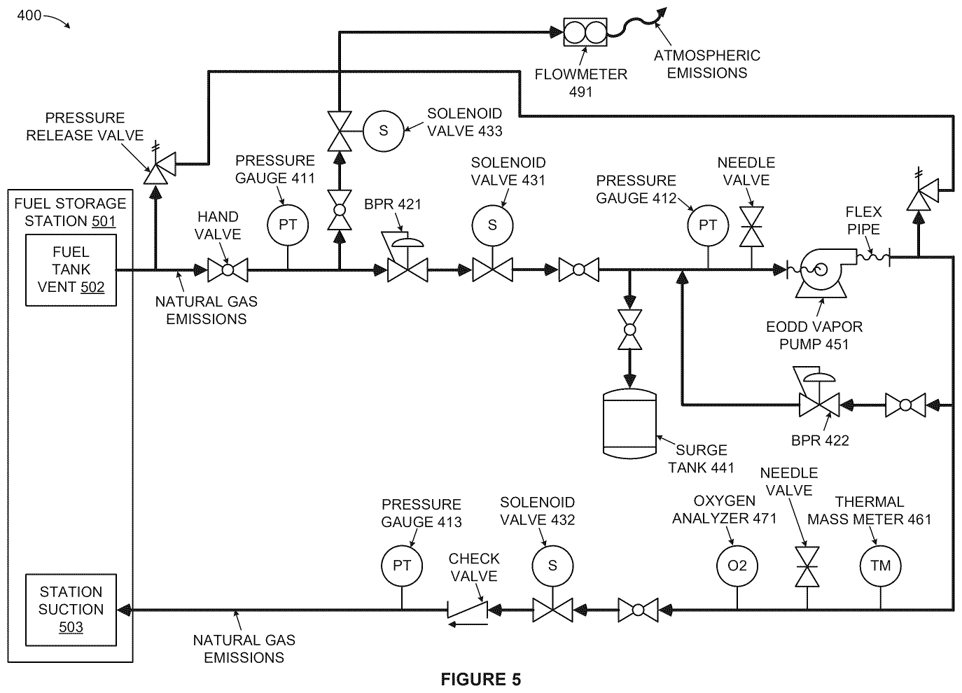

FIG. 5 illustrates an alternative embodiment of natural gas emissions capture system 400. In this example, compressor station 401 is replaced with fuel storage station 501. Fuel storage station 501 comprises fuel tank vent 502 and station suction 503. Oil tank 442, oil pump 452, level gauge 481, and flowmeter 492 are omitted. In some examples, fuel storage station 501 receives and stores a liquid hydrocarbon product (e.g., oil) in a storage tank. Natural gas and other volatile organic compounds are dissolved in the liquid hydrocarbon product. When in the storage tank, the natural gas and/or other volatiles evaporate from the liquid hydrocarbon product to fill the free space of the storage tank. In conventional hydrocarbon storage, excess natural gas is flared to inhibit excessive pressure. The flaring burns the natural gas to form carbon dioxide where it is released to the atmosphere. However, this reaction does not always run to completion and so a portion of the natural gas (e.g., methane) is still released into the atmosphere. In this example, the storage tank is equipped with fuel tank vent 502. The evaporated natural gas vapors exit the fuel tank via fuel tank vent 502 and travel towards pressure gauge 411. At this point, natural gas emissions capture system 400 operates to capture the natural gas emissions, detect bypass conditions, and enter/exit bypass mode as described with respect to FIG. 4. After the natural gas emissions have been pressured by EODD vapor pump 451 and measured by thermal mass meter 461 and oxygen analyzer 471, the captured natural gas is delivered to station suction 503. Station suction 503 is representative of a natural gas storage tank valve, pipeline valve, and/or some other type of natural gas storage receptacle.

FIG. 6 illustrates PLC 601 in natural gas emissions capture system 400. PLC 601 is representative of a control system to control setpoints, generate/transfer data characterizing the system operations, detect bypass conditions, enter/exit bypass mode, and generate/transfer alarms indicating system faults. PLC 601 comprises an example of process controller 141 illustrated in FIG. 1, however process controller 141 may differ. PLC 601 is communicatively and electrically coupled with pressure gauges 411-413, solenoid valves 431-433, pumps 451 and 452, thermal mass meter 461, oxygen analyzer 471, level gauge 481, and flowmeters 491 and 492.

In some examples, PLC 601 receives pressure measurements from pressure gauges 411-413, mass flowrate measurements from thermal mass meter 461, oxygen measurements from oxygen analyzer 471, flowrates from flowmeters 491 and 492, and level measurements from level gauge 481. PLC 601 generates control signaling (CNT.) to set the motor speed of EODD pump 451 based on the suction pressure reported by pressure gauge 412. The control signaling drives a VFD on EODD vapor pump 451 to control the electric motor speed of EODD pump 451. The pump VFD varies the frequency of the input electricity to achieve a pump speed that corresponds to a desired suction pressure (e.g., 0.25 psi). PLC 601 generates control signaling to activate/deactivate oil pump 452 based on the level measurements reported by level gauge 481. PLC 601 may utilize PID based control, machine learning assisted control, dead man's switch control, and/or some other type of control scheme to generate the pump control signaling.

PLC 601 compares the pressure measurements received from gauges 411 and 413 to low pressure and high-pressure thresholds to detect bypass conditions. PLC 601 compares the oxygen concentration measurements received from oxygen analyzer 471 to an oxygen threshold to detect bypass conditions. When any of the bypass thresholds are triggered, PLC 601 transfers control signaling to close solenoid valves 431 and 432, open solenoid valve 433, and deactivate EODD vapor pump 451. PLC 601 may generate and transfer alerts to system operators indicating the bypass conditions as well as data characterizing the bypass condition. The alert may be delivered via text message, email, operator portal message, Local Area Network (LAN) message, and the like. For example, PLC 601 may drive a communication system (not illustrated) to transfer a text message to an operator indicating natural gas emissions capture system 400 has entered bypass due to threshold levels of oxygen in the system, threshold low/high input pressures, and/or threshold low/high output pressures. The alerts may comprise predicted causes and recommended actions to resolve the bypass conditions. PLC 601 continues monitoring the thresholds to detect when bypass conditions subside. When none of the bypass thresholds are triggered, PLC 601 transfers control signaling to open solenoid valves 431 and 432, close solenoid valve 433, and activate EODD vapor pump 451. PLC 601 may transfer additional notifications to system operators indicating that the bypass conditions have subsided.

PLC 601 generates and transfers data reports that comprises the measurements, flowrates, and time data received from gauges 411-413, meter 461, analyzer 471, gauge 481, and flowmeters 491 and 492. The data reports may comprise averages, cumulative values, time-series data, and/or some other type of data representation. For example, PLC 601 may generate a data report that graphically depicts input pressure, suction pressure, output pressure, EODD vapor pump speed, captured natural gas mass flowrate, oxygen concentration, bypassed natural gas flowrate, lubrication oil flowrate, and oil tank level for every minute over a 24-hour operating period. The data reports may comprise graphs, charts, and/or other visual aids to depict the data.

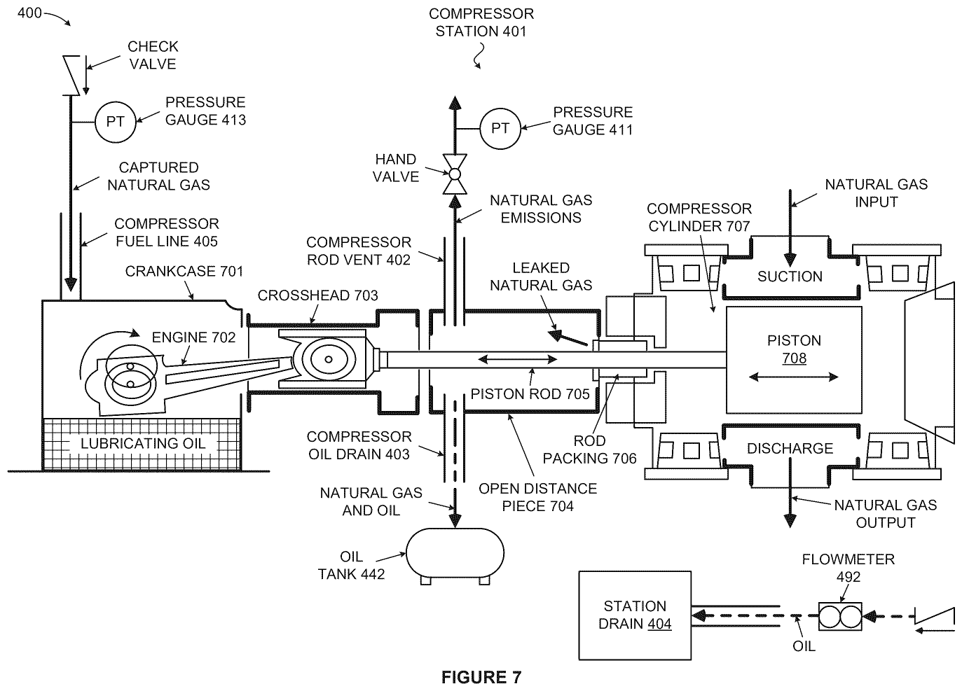

FIG. 7 illustrates compressor station 401 in natural gas emissions capture system 400. Compressor station 401 comprises compressor rod vent 402, compressor oil drain 403, station drain 404, compressor fuel line 405, crankcase 701, engine 702, crosshead 703, open distance piece 704, piston rod 705, rod packing 706, compressor cylinder 707, and piston 708. Compressor station 401 comprises an example of emissions source 101 illustrated in FIG. 1, however emissions source 101 may differ.

In some examples, crank case 701 houses engine 702. Engine 702 is an example of a natural gas-powered rotating motor. Engine 702 is operatively coupled to crosshead 703. Crosshead 703 converts the rotational energy supplied by engine 703 into linear energy. Crosshead 703 extends and retracts piston rod 705 to drive piston 708. At the start of the compression cycle, piston 708 is in a retracted position and compressor cylinder 707 is filled with natural gas. As engine 702 rotates, crosshead 703 extends piston rod 705 which moves piston 708 into the extend position. The movement of piston 708 compresses the natural gas to increase the pressure of the natural gas. The pressurized natural gas is driven out of the discharge end of the compressor cylinder 707 as the natural gas output. As engine 702 continues to rotate, crosshead 703 retracts piston rod 705 which moves piston 708 into the retracted position. The movement of piston 708 reduces the pressure within compressor cylinder 707. The reduction of pressure draws in natural gas input through the suction end of compressor cylinder 707. The natural gas input fills compressor cylinder 707 and the compression cycle restarts.

Rod packing 706 provides a seal on piston rod 705 to contain natural gas within compressor cylinder 707. Rod packing 706 comprises components like flanges, gaskets, packing cups, O-rings, and lubrication. The O-rings are housed in the packing cups and fitted onto piston rod 705. The interface between the O-rings and piston rod 705 is lubricated. The O-rings are fitted snuggly onto piston rod, but are designed to be loose enough to allow a portion of the natural gas in compressor cylinder 707 to leak into open distance piece 704. As such, a portion of the natural gas leaks into open distance piece 704 through rod packing 706 during the compression cycle. It should be noted that natural gas may also leak into open distance piece 704 engine 702 is not operating. This arrangement is intended to extend the lifetime of rod packing 706. For example, a rod packing system that completely sealed compressor cylinder 707 would increase the wear on the O-rings by the piston rod and reduce the useful lifetime of the rod packing. The leaked natural gas enters open distance piece 704 and is vented via compressor rod vent 402 towards the hand valve and pressure gauge 411. The natural gas emissions are pressurized by EODD vapor pump 451 and returned to compressor station 401 via the check valve and pressure gauge 413. The captured natural gas is fed to compressor fuel line 405. The natural gas enters the combustion chamber of engine 702 via compressor fuel line 405 where it is burned to power engine 702. It should be appreciated that the natural gas that fuels engine 702 is under pressure. As such, EODD vapor pump 451 pressurizes the captured natural gas to a pressure that exceeds the pressure of the fuel natural gas which allows the captured natural gas to flow into compressor fuel line 405.

As engine 702, crosshead 703, and piston rod 705 operate, the lubrication oil leaks into open distance piece 704. For example, the lubrication oil may drip off of piston rod 705 into open distance piece 704 as piston rod 705 extends and retracts to drive piston 708. The leaked lubrication oil drains out of open distance piece 704 through compressor oil drain 403 to oil tank 442. The natural gas leaked into open distance piece 704 may also leak through compressor oil drain 403 and/or may dissolve into the leaked lubrication oil. The natural gas that enters oil tank 442 is vented out of oil tank 442 and joined with the natural gas flow from compressor rod vent 402. The lubrication oil in oil tank 442 is pumped out of oil tank 442 by oil pump 452 when the oil level exceeds a threshold. The pumped oil is returned to compressor station 401 via the check valve and flowmeter 492 where it is disposed of through station drain 404. The flowrate data generated by flowmeter 492 may be used to identify when lubrication oil in compressor station 401 is low and/or needs to be replaced.

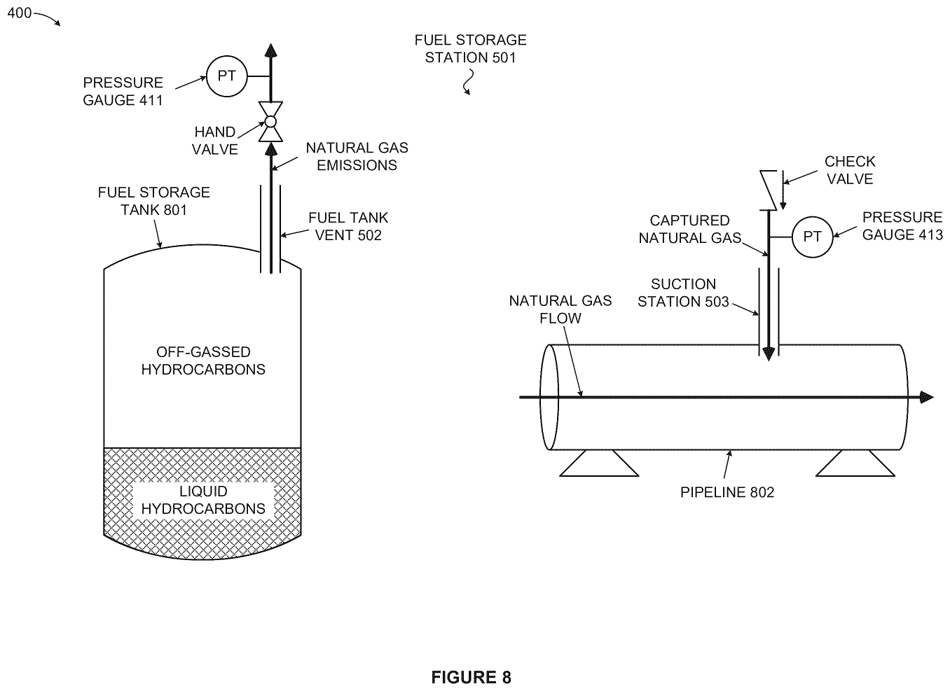

FIG. 8 illustrates fuel storage station 501 in natural gas emissions capture system 400. Fuel storage station 502 comprises fuel tank vent 502, suction station 503, fuel storage tank 801, and pipeline 802. Fuel storage station 501 comprises an example of emissions source 101 illustrated in FIG. 1, however emissions source 101 may differ.

In some examples, fuel storage tank 801 receives and stores liquid hydrocarbons like oil, petroleum, and the like. Natural gas and other volatile organic compounds dissolve into liquid hydrocarbons. When stored in fuel storage tank 801, the dissolved natural gas off-gasses from the liquid hydrocarbons to fill the free space in fuel storage tank 801. The natural gas is vented from fuel storage tank 801 through fuel tank vent 502 towards the hand valve and pressure gauge 411. The natural gas emissions are compressed by EODD vapor pump 451 and returned to fuel storage station 501 via the check valve and pressure gauge 413. The captured natural gas enters suction station 503 where it is fed into pipeline 802 and joined with the natural gas flow in pipeline 802. It should be appreciated that the natural gas within pipeline 802 is under pressure. As such, EODD vapor pump 451 pressurizes the captured natural gas to a pressure that exceeds the pressure of the natural gas within pipeline 802 which allows the captured natural gas to flow into pipeline 802.

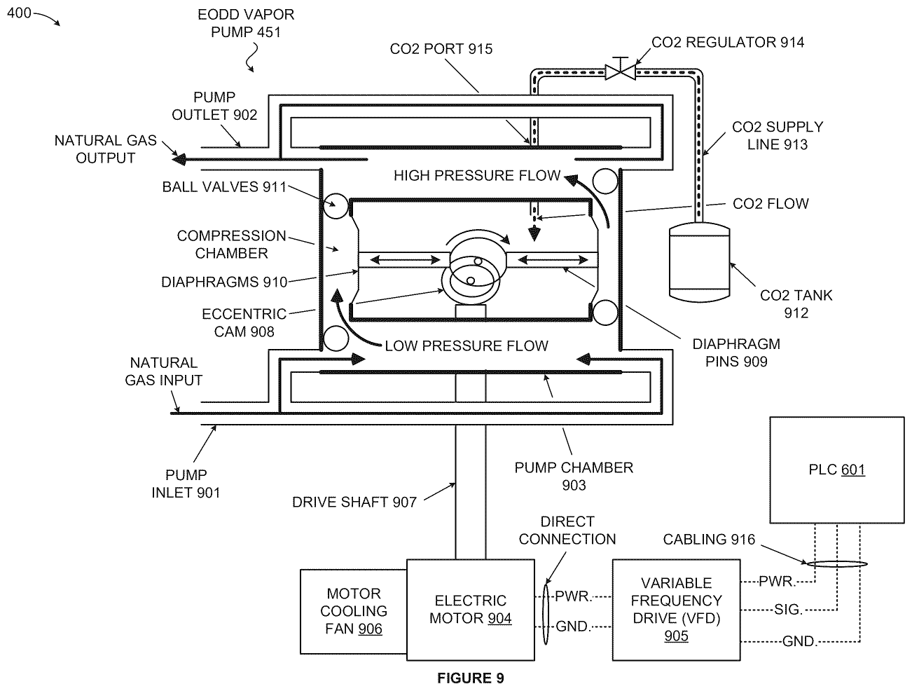

FIG. 9 illustrates EODD vapor pump 451 in natural gas emissions capture system 400. EODD vapor pump 451 comprises pump inlet 901, pump outlet 902, pump chamber 903, electric motor 904, VFD 905, motor cooling fan 906, drive shaft 907, eccentric cam 908, diaphragm pins 909, diaphragms 910, ball valves 911, carbon dioxide (CO₂) tank 912, carbon dioxide supply line 913, carbon dioxide regulator 914, carbon dioxide port 915, and cabling 916. Diaphragm pins 906 are typically mounted to a support carriage that is coupled to eccentric cam 908, however the support carriage is omitted for clarity. Cabling 916 comprises sheathed metallic wires that support a power (PWR.) link, signaling (SIG.) link, and ground (GND.) link. VFD 905 is communicatively coupled to electric motor 904 and motor colling fan 906 over a direct connection that supports a power link and ground link. EODD vapor pump 451 comprises an example of EODD vapor pump 131 illustrated in FIG. 1, however EODD vapor pump 131 may differ.

In some examples, PLC 601 generates control signaling that selects a rotation speed for electric motor 904 based on suction pressure measurements received from pressure gauge 412. The selected rotational speed corresponds to a natural gas input pressure. For example, PLC 601 may maintain a data structure (e.g., a performance curve) that correlates motor speeds to suction pressures and may generate control signaling that sets a motor speed based on correlations provided by the data structure. PLC 601 transfers the control signaling and electrical power and provides electrical ground to VFD 905 over the power, signaling, and ground links supported by cabling 916.

VFD 905 controls the rotational speed of electric motor 904 by varying the frequency of the electricity supplied to electric motor 904. VFD 905 receives and executes the control signaling. The executed control signaling indicates frequencies for the electric current supplied to electric motor 904. The processing circuitry in VFD 905 directs frequency control elements like rectifiers, capacitors, invertors, inductors, and the like to impart the signaled frequencies into the electric power supplied to electric motor 904. The control elements encode the desired frequencies into the electricity in response to the direction from the processing circuitry. For example, VFD 905 may utilize a Voltage-Source Inverter (VSI) drive, Current-Source Inverter (CSI) drive, and/or some other type of drive to modify the frequency of the input electricity. VFD 905 transfers the electric power and provides an electric ground to electric motor 904 and motor colling fan 906 over the power link and ground link supported by the direct connection.

Electric motor 904 comprises a 5-Horsepower (HP) AC motor that rotates in response to receiving the power from VFD 905. The rotational speed of electric motor 904 is governed by the frequency of the received electric power. For example, electric motor 904 may have a maximum rotational speed of 1750 Rotations Per Minute (RPM) and may be powered by a 3-phase 208-230/460V current with a maximum amperage load of 13.1/6.6 amps. Motor cooling fan 906 blows air at electric motor 904 to remove excess heat. Motor colling fan 906 allows for 100% downturn which provides a speed range from 0-1750 RPM without risking motor overheating. The rotation of electric motor 904 turns drive shaft 907 which in turn drives eccentric cam 908 within pump chamber 903. Eccentric cam 908 comprises a circular disk fixed to drive shaft 907 which converts the rotational motion of drive shaft 907 into linear reciprocating motion. For example, EODD vapor pump 451 may comprise a maximum reciprocating speed of 174 Cycles Per Minute (cpm).

Pump chamber 903 and the other process pressure sections and valves of EODD pump 903 may be constructed from stainless steel. Diaphragms 910 are mounted to the internal wall of pump chamber 903. Diaphragm pins 909 mechanically couple diaphragms 910 to eccentric cam 908. Diaphragms 910 comprise flexible members (e.g., rubber disks, polytetrafluoroethylene (PTFE), etc.) that are impermeable to fluid (e.g., natural gas, carbon dioxide, etc.). As drive shaft 907 spins, eccentric cam 908 moves diaphragm pins 909 back-and-forth. This reciprocating motion compresses and expands diaphragms 910 to draw in low pressure natural gas input, pressurize the natural gas input, and transfer high pressure natural gas output. EODD vapor pump 451 may pressurize natural gas at temperatures as low as −40° F. (−40° C.) and as high as 220° F. (104° C.). The right side one of diaphragms 910 is illustrated in FIG. 9 in the compressed state while the left side one of diaphragms 910 is illustrated in FIG. 9 in the expanded state.

When diaphragms 910 are in the expanded state, the low-pressure side one of ball valves 911 opens while the high-pressure side one of ball valves 911 closes. The open low-pressure ball valve allows low pressure natural gas to flow into EODD pump 451 through the flex pipe and pump inlet 901 and into the compression chamber. For example, pump inlet 901 may comprise a 1-inch diameter pipe. The closed high-pressure ball valve inhibits backflow of high-pressure natural gas into the compression chamber. The compression of diaphragms 910 pressurizes natural gas within the compression chamber. For example, EODD vapor pump 451 may produce a maximum output pressure of around 150 psi and may pull a vacuum of up to 27 inches of Mercury (inHG). When diaphragms 910 are in the compressed state, the low-pressure side one of ball valves 911 closes while the high-pressure side one of ball valves 911 opens. The open high-pressure ball valve allows the pressurized natural gas to exit the compression chamber and flow out of EODD pump 451 through pump outlet 902 and the flex pipe. For example, pump outlet 902 may comprise a 1-inch diameter pipe. The closed low-pressure ball valve inhibits backflow of pressurized natural gas into the inlet side of EODD vapor pump 451.

The inner walls of pump chamber 903 and diaphragms 910 form an enclosed space where eccentric cam 908 and diaphragm pins 909 are located. Since diaphragms 910 are constructed from a flexible material and are operating under pressure, the enclosed space is pressurized. Carbon dioxide regulator 914 opens and is set to a desired psi. The enclosed space psi depends in part on the rigidity of diaphragms 910, the input psi, and the output psi. For example, when the outlet pressure is equal to or less than 100 psi, the enclosed space psi may be set to the outlet pressure. Pressurized carbon dioxide flows out of carbon dioxide tank 912 through carbon dioxide supply line 912. For example, supply line 912 may comprise a ¼ inch diameter hose. The carbon dioxide enters the enclosed space of EODD pump 451 through carbon dioxide port 915. In some examples, EODD pump 451 may comprise additional or modified pump heads to achieve higher discharge pressures.

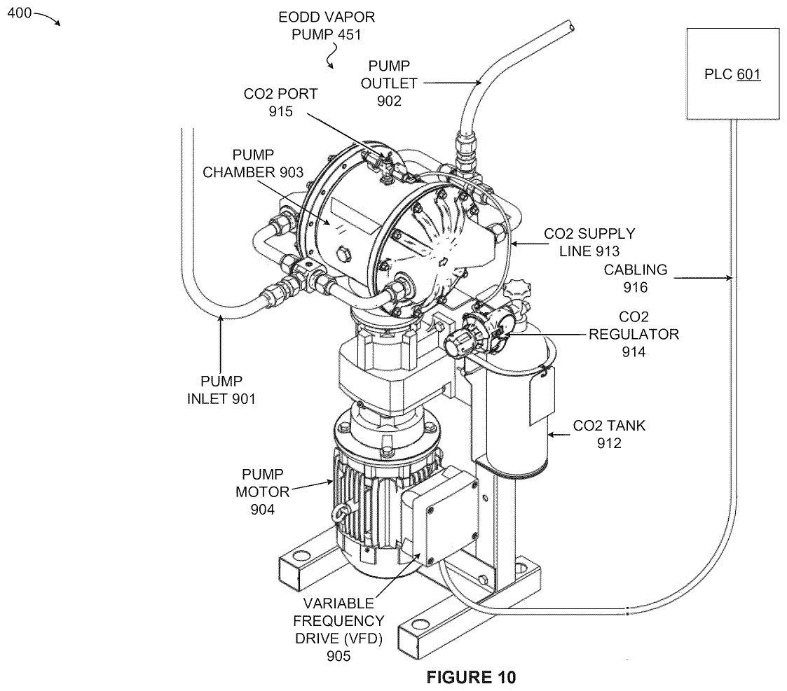

FIG. 10 illustrates an external schematic view of EODD vapor pump 451 in natural gas emissions capture system 400. The schematic view shows pump inlet 901, pump outlet 902, the outer walls of pump chamber 903, pump motor 904, VFD 905, carbon dioxide tank 912, carbon dioxide supply line 913, carbon dioxide regulator 914, carbon dioxide port 915, and cabling 916. The view of internal components (e.g., motor cooling fan 906, drive shaft 907, eccentric cam 908, diaphragm pins 909, diaphragms 910, and ball valves 911) is obstructed.

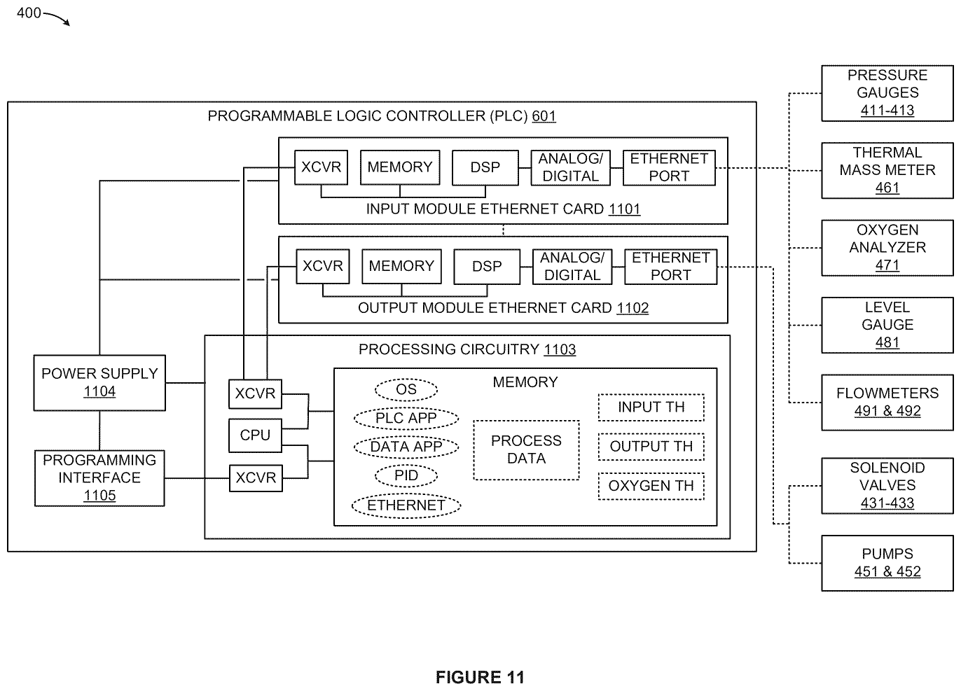

FIG. 11 illustrates PLC 601 in natural gas emissions capture system 400. PLC 601 comprises input module ethernet card 1101, output module ethernet card 1102, processing circuitry 1103, power supply 1104, and programming interface 1105. While illustrated as comprising an ethernet device, in other examples, PLC 601 may utilize a different wireless/wireline networking technology (e.g., WiFi).

In some examples, input module ethernet card 1101 and output module ethernet card 1102 comprise ethernet ports, analog-to-digital interfaces, DSPs, memories, and transceivers that are coupled over bus circuitry. Input module ethernet card 1101 is responsible for receiving process data and output module ethernet card 1102 is responsible for transferring control signaling, alarms, data reports, and the like. In other examples, ethernet cards 1101 and 1102 may be combined. Processing circuitry 1103 comprises memory, CPU, user interfaces and components, and transceivers that are coupled over bus circuitry. The memory in processing circuitry 604 stores an operating system (OS), a PLC application, a data aggregation application (DATA APP), a PID control application (PID), an ethernet networking application (ETHERNET), collected process data, input pressure thresholds (INPUT TH), output pressure thresholds (OUTPUT TH), and oxygen concentration thresholds (OXYGEN TH).

The ethernet port in input module ethernet card 1101 is coupled to pressure gauges 411-413, thermal mass meter 461, oxygen analyzer 471, level gauge 481, and flowmeters 491 and 492 over a wired connection. The ethernet port in output module ethernet card 1102 is coupled to solenoid valves 431-433, EODD vapor pump 451, and oil pump 452 over a wired connection. Output module ethernet card 1102 is also typically coupled to external systems to report process data, transfer alarms, and the like. Transceivers in ethernet cards 1101 and 1102 are coupled to transceivers in processing circuitry 1103. Transceivers in processing circuitry 1103 are coupled to programming interface 1105 like displays, controllers, and memory. The CPU in processing circuitry 1103 executes the operating system, PLC application, data aggregation application, PID control application, and ethernet networking application to exchange control signaling and data with gauges 411-413, solenoid valves 431-433, EODD vapor pump 451, oil pump 452, thermal mass meter 461, oxygen analyzer 471, level gauge 481, and flowmeters 491 and 492. Power supply 1104 is electrically coupled to ethernet cards 1101 and 1102, processing circuitry 1103, and programming interface 1105. Power supply 1104 controls current/voltage to the other components of PLC 601.

The operating system manages the hardware and software components of PLC 601 and provides common services to the other application stored in the memory. The PLC application comprises capabilities for control signal forwarding, input data processing, PLC subcomponent control, bypass mode detection, and operator alarm generation. The data aggregation application comprises capabilities for process data handling, process data aggregation, and process data report generation. The PID control application comprises capabilities for control loop implementation, control signal generation, and setpoint maintaining. The process data is representative of data received over input module ethernet card 1101 and aggregated by the data aggregation application. The process data comprises information like input pressure over time, suction pressure over time, output pressure over time, mass flow rate over time, cumulative natural gas mass, oxygen concentration over time, oil tank level over time, oil flowrate over time, cumulative oil volume, bypassed natural gas flowrate over time, cumulative bypassed natural gas volume, and pump speed over time. The input pressure, output pressure, and oxygen concentration thresholds define when bypass conditions occur. The PLC application compares the received process data to these thresholds to detect bypass conditions.

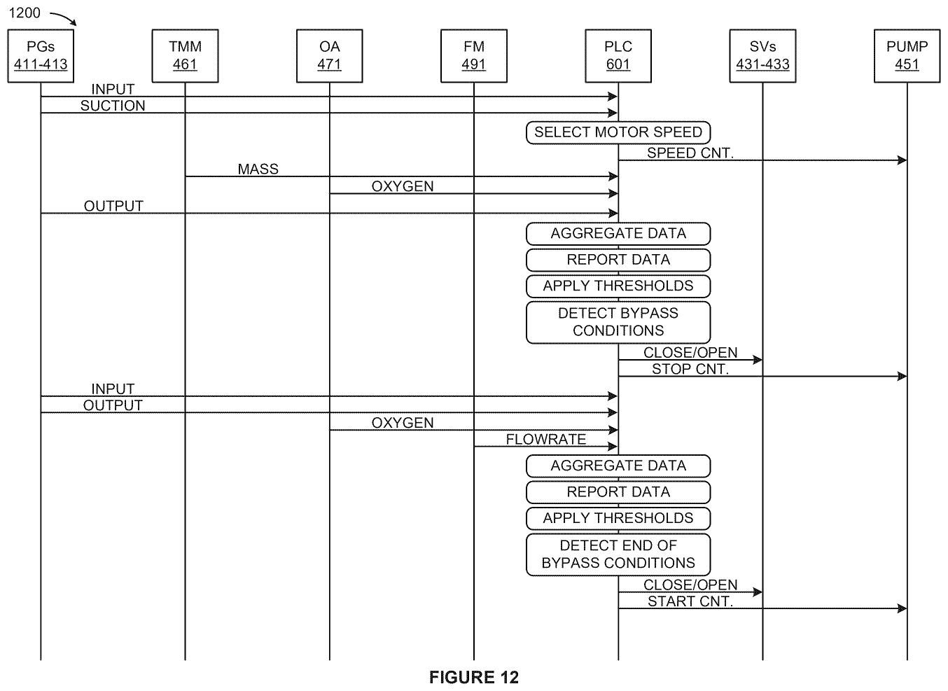

FIG. 12 illustrates process 1200. Process 1200 comprises an exemplary operation of natural gas emissions capture system 400 to capture and recycle natural gas. Process 1200 comprises an example of process 200 illustrated in FIG. 2 and process 300 illustrated in FIG. 3, however processes 200 and 300 may differ. In other examples, process 1200 may differ.

In some examples, compressor rod vents 402 leak natural gas at 0.5 psi. Pressure gauge (PG) 411 measures the pressure of the leaked natural gas and reports the input pressure to PLC 601. BPR 421 controls upstream pressure and passes the natural gas through solenoid valve (SV) 431 towards EODD vapor pump 451. Natural gas emissions from oil tank 442 are joined with the flow from BPR 421. Surge tank 441 fills to stabilize the natural gas volume entering EODD vapor pump 451. Pressure gauge 412 reports the natural gas suction pressure to PLC 601. PLC 601 stores an input pressure setpoint and an output pressure setpoint for EODD vapor pump 451. The input pressure setpoint is 0.25 psi and the output pressure setpoint is 50 psi. PLC 601 executes the PID application which generates control signaling to adjust the speed of pump motor 904 based on the difference between the input pressure setpoint and the suction pressure. The PID application provides the control output to the PLC application. The PLC application drives the ethernet application to transfer the control signaling over output module ethernet card 1102.

VFD 905 receives the control signaling from PLC 601 over cabling 916. VFD 905 executes the control signaling to determine frequencies for the electric current supplied to electric motor 904. VFD 905 utilizes frequency control elements like rectifiers, capacitors, invertors, inductors, and the like to encode the frequencies into the power supplied to electric motor 904. VFD 905 supplies the encoded power to electric motor 904 and powers motor cooling fan 906. Electric motor 904 rotates at a speed dictated by the encoded power. Motor cooling fan 906 draws off excess heat from motor 904. Electric motor 904 spins drive shaft 907 which in turn spins eccentric cam 908. Cam 908 converts the rotational motion into linear motion to oscillate diaphragm pins 909. The oscillation of diaphragm pins 909 compresses and expands diaphragms 910 which draws upstream low-pressure natural gas into pump chamber 903 through pump inlet 901, pressurizes the natural gas from 0.25 psi to 50 psi, and expels high pressure natural gas out of pump chamber 903 through pump outlet 902.

EODD pump 451 transfers the pressurized natural gas towards compressor fuel line 405. When input natural gas volume is too low, BPR 422 is triggered, and a portion of the pressurized natural gas recirculates to the input side of EODD pump 451. Thermal mass meter (TMM) 461 measures the mass flow rate of the natural gas and reports the mass flow rate to PLC 601. Oxygen analyzer (OA) 471 measures the oxygen concentration of the natural gas and reports the oxygen concentration to PLC 601. The pressurized natural gas flows through solenoid valve 432 and enters compressor fuel line 405 where it is burned to power engine 702. Pressure gauge 413 measures the output pressure of the natural gas and reports the output pressure to PLC 601.

The data aggregation application in PLC 601 receives the input pressure, suction pressure, mass flow rate, oxygen concentration, and output pressure over input module ethernet card 1101 and stores the received measurements as process data. The data aggregation application generates a report that aggregates and characterizes process data (e.g., using visual aids). The data aggregation application drives the ethernet application to transfer the data report over output module ethernet car 1102 to an external system (e.g., a cloud-based data storage service associated with compressor station 401). The process data may be live streamed or delivered in batches.

The PLC application in PLC 601 compares the received input pressure, output pressure, and oxygen concentration measurements to their respective thresholds. In this example, the input low-pressure threshold is 0.20 psi, the input high-pressure threshold is 2.00 psi, the output low-pressure threshold is 20 psi, the output high-pressure threshold is 60 psi, and the oxygen concentration threshold is 0.5%. It should be appreciated that these numbers are exemplary and may differ in other examples. The PLC application detects that the measured input pressure is less than 0.20 psi, and that the oxygen concentration is greater than 0.5%. In response, the PLC application triggers bypass mode. The PLC application generates control signaling to close solenoid valves 431 and 432, open solenoid valve 433, and deactivate EODD vapor pump 451. The PLC generates and drives the ethernet application to transfer an alarm that indicates system 400 is entering bypass mode over output module ethernet card 1102 for delivery to human operators. The PLC application drives the ethernet application to transfer the control signaling to solenoid valves 431-433 and EODD vapor pump 451 over output module ethernet card 1102. VFD 905 receives its respective control signaling and stops powering electric motor 904. Solenoid valves 431-433 receive their respective control signaling which drives actuators in valves 431-433 to close valves 431 and 432 and open valve 433. Compressor rod vents 402 and oil tank 442 continue to leak natural gas. Since solenoid valve 431 is closed and solenoid valve 433 is open, the leaked natural gas is routed to flowmeter 491. Flowmeter 491 measures and reports the flowrate of the bypassed natural gas to PLC 601 before venting the natural gas to the atmosphere.

During bypass mode, pressure gauges 411 and 413 measure and report input and output pressure to PLC 601, and oxygen analyzer 471 measures and reports oxygen concentration to PLC 601. The data aggregation application in PLC 601 receives the bypass mode input pressure, bypassed natural gas flow rate, the bypass mode oxygen concentration, and the bypass mode output pressure over input module ethernet card 1101 and stores the received measurements as process data. The data aggregation application generates and transfers a report that aggregates and characterizes the process data collected during bypass mode.

The PLC application in PLC 601 compares the received bypass input pressure, output pressure, and oxygen concentration measurements to their respective thresholds to detect when bypass conditions have been resolved. The PLC application detects that the measured input pressure is now greater than 0.20 psi and that the oxygen concentration is now less than 0.5%. In response, the PLC application determines to end bypass mode. The PLC application generates control signaling to open solenoid valves 431 and 432, close solenoid valve 433, and activate EODD vapor pump 451. The PLC application drives the ethernet application to transfer the control signaling to solenoid valves 431-433 and EODD vapor pump 451 over output module ethernet card 1102. The PLC application drives the ethernet application to transfer a notification that indicates system 400 is leaving bypass mode to the operators over output module ethernet card 1102. VFD 905 receives its respective control signaling and begins powering electric motor 904 to restart the flow of pressurized natural gas towards compressor fuel line 405. Solenoid valves 431-433 receive their respective control signaling which drives actuators in valves 431-433 to open valves 431 and 432 and close valve 433. Compressor rod vents 402 and oil tank 442 continue to leak natural gas. Since solenoid valve 431 is open and solenoid valve 433 is closed, the leaked natural gas stops routing to flowmeter 491 and normal system operation resumes.

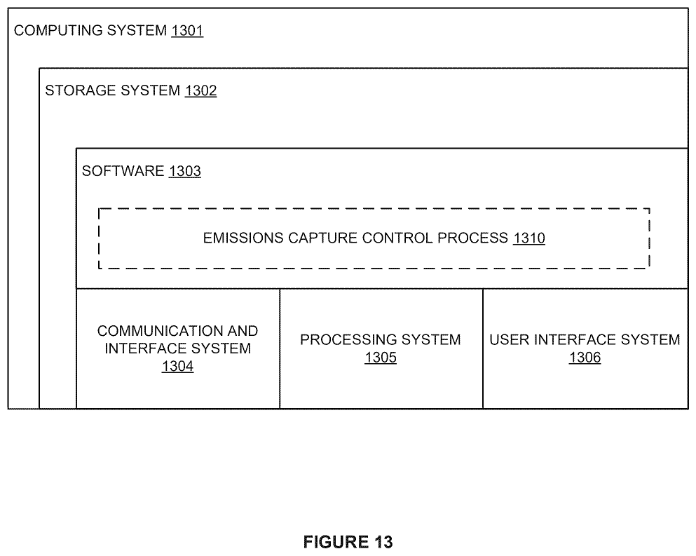

FIG. 13 illustrates computing system 1301 according to various embodiments of the present technology. Computing system 1301 is representative of any system or collection of systems with which the various operational architectures, processes, scenarios, and sequences disclosed herein for controlling hydrocarbon emissions capture systems. For example, computing system 1301 may be representative of process controller 141, PLC 601, VFD 905, and/or any other computing device contemplated herein. Computing system 1301 may be implemented as a single apparatus, system, or device or may be implemented in a distributed manner as multiple apparatuses, systems, or devices. Computing system 1301 includes, but is not limited to, storage system 1302, software 1303, communication interface system 1304, processing system 1305, and user interface system 1306. Processing system 1305 is operatively coupled with storage system 1302, communication interface system 1304, and user interface system 1306.

Processing system 1305 loads and executes software 1303 from storage system 1302. Software 1303 includes and implements emissions capture control process 1310, which is representative of any of the gas collection control processes described with respect to the preceding Figures, including but not limited to the PLC controlling, motor speed controlling, bypass detecting, alarm generating, data reporting, and data aggregating operations described with respect to the preceding Figures. For example, emissions capture control process 1310 may be representative of process 200 illustrated in FIG. 2, process 300 illustrated in FIG. 3, and/or process 1200 illustrated in FIG. 12. When executed by processing system to control hydrocarbon emission capture systems, software 1303 directs processing system 1305 to operate as described herein for at least the various processes, operational scenarios, and sequences discussed in the foregoing implementations. Computing system 1301 may optionally include additional devices, features, or functionality not discussed for purposes of brevity.

Processing system 1305 may comprise a micro-processor and other circuitry that retrieves and executes software 1303 from storage system 1302. Processing system 1305 may be implemented within a single processing device but may also be distributed across multiple processing devices or sub-systems that cooperate in executing program instructions. Examples of processing system 1305 include general purpose CPUs, GPUs, DSPs, ASICs, FPGAs, analog computing devices, and logic devices, as well as any other type of processing device, combinations, or variations thereof.

Storage system 1302 may comprise any computer readable storage media readable by processing system 1305 and capable of storing software 1303. Storage system 1302 may include volatile, nonvolatile, removable, and/or non-removable media implemented in any method or technology for storage of information, such as computer readable instructions, data structures, program modules, or other data. Examples of storage media include RAM, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1302 may also include computer readable communication media over which at least some of software 1303 may be communicated internally or externally. Storage system 1302 may be implemented as a single storage device but may also be implemented across multiple storage devices or sub-systems co-located or distributed relative to each other. Storage system 1302 may comprise additional elements, such as a controller, capable of communicating with processing system 1305 or possibly other systems.

Software 1303 (including emissions capture control process 1310) may be implemented in program instructions and among other functions may, when executed by processing system 1305, direct processing system 1305 to operate as described with respect to the various operational scenarios, sequences, and processes illustrated herein. For example, software 1303 may include program instructions for generating control signaling to drive a VFD to control EODD vapor pump motor speed as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1303 may include additional processes, programs, or components, such as operating system software, virtualization software, or other application software. Software 1303 may also comprise firmware or some other form of machine-readable processing instructions executable by processing system 1305.

In general, software 1303 may, when loaded into processing system 1305 and executed, transform a suitable apparatus, system, or device (of which computing system 1301 is representative) overall from a general-purpose computing system into a special-purpose computing system customized to control emissions capture systems as described herein. Indeed, encoding software 1303 on storage system 1302 may transform the physical structure of storage system 1302. The specific transformation of the physical structure may depend on various factors in different implementations of this description. Examples of such factors may include, but are not limited to, the technology used to implement the storage media of storage system 1302 and whether the computer-storage media are characterized as primary or secondary storage, as well as other factors.

For example, if the computer readable storage media are implemented as semiconductor-based memory, software 1303 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1304 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1301 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and an extended discussion of them is omitted for the sake of brevity.

While some examples provided herein are described in the context of computing devices for emissions capture system control, it should be understood that the condition systems and methods described herein are not limited to such embodiments and may apply to a variety of other environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

What is claimed is:

1. A method to collect hydrocarbon emissions, the method comprising:
a pressure regulator receiving hydrocarbon emissions at an input pressure from an emissions source, maintaining the hydrocarbon emissions at the input pressure, and passing the hydrocarbon emissions at a pump suction pressure to an Electric Operated Dual Diaphragm (EODD) vapor pump;
the EODD vapor pump ingesting the hydrocarbon emissions at the pump suction pressure, pressurizing the hydrocarbon emissions to an output pressure, and transferring the hydrocarbon emissions at the output pressure for delivery to a hydrocarbon emissions collector;
a pump pressure gauge measuring the pump suction pressure of the hydrocarbon emissions and reporting the pump suction pressure to a process controller; and
the process controller controlling a motor speed of the EODD vapor pump to maintain the hydrocarbon emissions at the pump suction pressure.

2. The method of claim 1 further comprising:
an input pressure gauge measuring the input pressure of the hydrocarbon emissions and reporting the input pressure to the process controller;
an output pressure gauge measuring the output pressure of the hydrocarbon emissions and reporting the output pressure to the process controller; and
an oxygen analyzer measuring oxygen content of the hydrocarbon emissions and reporting the oxygen content to the process controller.

3. The method of claim 2 further comprising:
the process controller receiving the input pressure, the output pressure, and the oxygen content, comparing the input pressure to an input pressure threshold, comparing the output pressure to an output pressure threshold, and comparing the oxygen content to an oxygen content threshold;
when one or more of the input pressure threshold, output pressure threshold, or oxygen content threshold are triggered, the process controller deactivating the EODD vapor pump, directing an input valve to close to stop the hydrocarbon emissions from reaching the EODD vapor pump, directing an output valve to close stop the hydrocarbon emissions from reaching the hydrocarbon emissions collector, and directing a bypass valve to open to release the hydrocarbon emissions to atmosphere; and
the process controller generating and transferring an alert that indicates the triggered ones of the input pressure threshold, output pressure threshold, or oxygen content threshold and that the hydrocarbon emissions are releasing to the atmosphere.

4. The method of claim 3 further comprising:
a bypass flowmeter measuring a volumetric flowrate of the hydrocarbon emissions released to the atmosphere and reporting the volumetric flowrate to the process controller; and
the process controller receiving the volumetric flowrate and generating and transferring a report that indicates the volumetric flowrate.

5. The method of claim 2 further comprising:
a flowmeter measuring a volumetric flowrate of the hydrocarbon emissions after pressurization by the EODD vapor pump and reporting the volumetric flowrate to the process controller; and
the process controller receiving the input pressure, the output pressure, the oxygen content, and the volumetric flowrate, generating a report that indicates the input pressure, the output pressure, the oxygen content, and the volumetric flowrate, and transferring the report.

6. The method of claim 1 wherein:
the hydrocarbon emissions comprise natural gas emissions;
the emissions source comprises a natural gas reciprocating compressor;
the hydrocarbon emissions collector comprises one or more of a fuel line for the natural gas reciprocating compressor or a suction station for a natural gas repository;
the pressure regulator receiving the hydrocarbon emissions at the input pressure from the emissions source comprises receiving the natural gas emissions at the input pressure from the natural gas reciprocating compressor; and
the EODD vapor pump transferring the hydrocarbon emissions at the output pressure for delivery to the hydrocarbon emissions collector comprises transferring the natural gas emissions at the output pressure for delivery to the one or more of the fuel line for the natural gas reciprocating compressor or the suction station for the natural gas repository.

7. The method of claim 6 wherein:
the emissions source comprises the natural gas reciprocating compressor and a lubrication oil collection pot for the natural gas reciprocating compressor; and
the pressure regulator receiving the hydrocarbon emissions at the input pressure from the natural gas reciprocating compressor comprises receiving the natural gas emissions at the input pressure from the natural gas reciprocating compressor and the lubrication oil collection pot for the natural gas reciprocating compressor.

8. The method of claim 7 further comprising:
a level gauge measuring an oil level of the lubrication oil collection pot and reporting the oil level to the process controller;
an oil pump pumping lubrication oil from the lubrication oil collection pot to maintain the oil level and transferring the lubrication oil for delivery to an oil drain;
a flowmeter measuring an oil volumetric flowrate of the lubrication oil transferred by the oil pump and reporting the oil volumetric flowrate to the process controller; and
the process controller controlling a motor speed of the oil pump to maintain the oil level of the lubrication oil collection pot, receiving the oil volumetric flowrate, generating a report that indicates the oil volumetric flowrate, and transferring the report.

9. The method of claim 1 wherein:
the hydrocarbon emissions comprise outgassed hydrocarbons from liquid hydrocarbons stored in a liquid hydrocarbon storage vessel;
the emissions source comprises the liquid hydrocarbon storage vessel;
the hydrocarbon emissions collector comprises a suction station for a gaseous hydrocarbon repository;
the pressure regulator receiving the hydrocarbon emissions at the input pressure from the emissions source comprises receiving the outgassed hydrocarbons at the input pressure from the liquid hydrocarbon storage vessel; and
the EODD vapor pump transferring the hydrocarbon emissions at the output pressure for delivery to the hydrocarbon emissions collector comprises transferring the outgassed hydrocarbons at the output pressure for delivery to the suction station for the gaseous hydrocarbon repository.

10. A system to collect hydrocarbon emissions, the system comprising:
a pressure regulator configured to:
receive hydrocarbon emissions at an input pressure from an emissions source;
maintain the input pressure of the hydrocarbon emissions; and
pass the hydrocarbon emissions at a pump suction pressure;
an Electric Operated Dual Diaphragm (EODD) vapor pump configured to:
ingest the hydrocarbon emissions at the pump suction pressure;
pressurize the hydrocarbon emissions to an output pressure; and
transfer the hydrocarbon emissions at the output pressure for delivery to a hydrocarbon emissions collector;
a pump pressure gauge configured to:
measure the pump suction pressure of the hydrocarbon emissions; and
report the pump suction pressure; and
a process controller configured to:
control a motor speed of the EODD vapor pump to maintain the hydrocarbon emissions at the pump suction pressure.

11. The system of claim 10 further comprising:
an input pressure gauge configured to measure the input pressure of the hydrocarbon emissions and report the input pressure to the process controller;
an output pressure gauge configured to measure the output pressure of the hydrocarbon emissions and report the output pressure to the process controller; and
an oxygen analyzer configured to measure oxygen content of the hydrocarbon emissions and report the oxygen content to the process controller.

12. The system of claim 11 wherein the process controller is further configured to:
receive the input pressure, the output pressure, and the oxygen content;
compare the input pressure to an input pressure threshold;
compare the output pressure to an output pressure threshold; and
compare the oxygen content to an oxygen content threshold; and wherein:
when one or more of the input pressure threshold, output pressure threshold, or oxygen content threshold are triggered, the process controller is further configured to:
deactivate the EODD vapor pump;
direct an input valve to close to stop the hydrocarbon emissions from reaching the EODD vapor pump;
direct an output valve to close stop the hydrocarbon emissions from reaching the hydrocarbon emissions collector;
direct a bypass valve to open to release the hydrocarbon emissions to atmosphere;
generate an alert that indicates the one or more of the input pressure threshold, output pressure threshold, or oxygen content threshold are triggered and that the hydrocarbon emissions are releasing to the atmosphere; and
transfer the alert.

13. The system of claim 12 further comprising:
a bypass flowmeter configured to measure a volumetric flowrate of the hydrocarbon emissions released to the atmosphere and report the volumetric flowrate to the process controller; and wherein:
the process controller is further configured to:
receive the volumetric flowrate;
generate a report that indicates the volumetric flowrate; and
transfer the report.

14. The system of claim 11 further comprising:
a flowmeter configured to measure a volumetric flowrate of the hydrocarbon emissions after pressurization by the EODD vapor pump and report the volumetric flowrate to the process controller; and wherein:
the process controller is further configured to:
receive the input pressure, the output pressure, the oxygen content, and the volumetric flowrate;
generate a report that indicates the input pressure, the output pressure, the oxygen content, and the volumetric flowrate; and
transfer the report.

15. The system of claim 10 wherein:
the hydrocarbon emissions comprise natural gas emissions;
the emissions source comprises a natural gas reciprocating compressor;
the hydrocarbon emissions collector comprises one or more of a fuel line for the natural gas reciprocating compressor or a suction station for a natural gas repository;
the pressure regulator is configured to receive the natural gas emissions at the input pressure from the natural gas reciprocating compressor; and
the EODD vapor pump is configured to transfer the natural gas emissions at the output pressure for delivery to the one or more of the fuel line for the natural gas reciprocating compressor or the suction station for the natural gas repository.

16. The system of claim 15 wherein:
the emissions source comprises the natural gas reciprocating compressor and a lubrication oil collection pot for the natural gas reciprocating compressor; and
the pressure regulator is configured to receive the natural gas emissions at the input pressure from the natural gas reciprocating compressor and the lubrication oil collection pot for the natural gas reciprocating compressor.

17. The system of claim 16 further comprising:
a level gauge configured to measure an oil level of the lubrication oil collection pot and report the oil level to the process controller;
an oil pump configured to pump lubrication oil from the lubrication oil collection pot to maintain the oil level and transfer the lubrication oil for delivery to an oil drain; and
a flowmeter configured to measure an oil volumetric flowrate of the lubrication oil transferred by the oil pump and report the oil volumetric flowrate to the process controller; and wherein:
the process controller is further configured to:
control a motor speed of the oil pump to maintain the oil level of the lubrication oil collection pot;
receive the oil volumetric flowrate;
generate a report that indicates the oil volumetric flowrate; and
transfer the report.

18. The system of claim 10 wherein:
the hydrocarbon emissions comprise outgassed hydrocarbons from liquid hydrocarbons stored in a liquid hydrocarbon storage vessel;
the emissions source comprises the liquid hydrocarbon storage vessel;
the hydrocarbon emissions collector comprises a suction station for a gaseous hydrocarbon repository;
the pressure regulator is configured to receive the outgassed hydrocarbons at the input pressure from the liquid hydrocarbon storage vessel; and
the EODD vapor pump is configured to transfer the outgassed hydrocarbons at the output pressure for delivery to the suction station for the gaseous hydrocarbon repository.

19. One or more non-transitory computer readable storage media having program instructions stored thereon to implement a control scheme for an emissions collection system, wherein the program instruction, when executed by a computing system, direct the computing system to perform operations, the operations comprising:
obtaining a pump suction pressure measurement that indicates pump suction pressure to an Electric Operated Dual Diaphragm (EODD) vapor pump, wherein the EODD vapor pump pressurizes and transfers captured hydrocarbon emissions;
controlling a motor speed of the EODD vapor pump to maintain the pump suction pressure at a set point based on the pump suction pressure measurement;
obtaining an input pressure measurement of the hydrocarbon emissions, an output pressure measurement of the hydrocarbon emissions, and an oxygen concentration measurement of the hydrocarbon emissions;
comparing the input pressure measurement to an input pressure threshold, the output pressure measurement to an output pressure threshold, and the oxygen content measurement to an oxygen content threshold;
detecting that one or more of the input pressure threshold, the output pressure threshold, or the oxygen content threshold are triggered;
in response, transferring control signals to deactivate the EODD vapor pump, close a pump input valve, close a pump output valve, and open a bypass valve to release the hydrocarbon emission to atmosphere.

20. The one or more computer readable storage media of claim 19, wherein the operations further comprise:
detecting that the input pressure threshold, the output pressure threshold, and the oxygen content threshold are no longer triggered; and
in response, transferring additional control signals to activate the EODD vapor pump, open the pump input valve, open the pump output valve, and close the bypass valve.
